(19) United States
(12) Patent Application Publication
(10) Pub. No.: US 2010/0176955 A1
(43) Pub. Date: Jul. 15, 2010

(54) High-Tech Animal Training System

(75) Inventors: James L. Jameson, Seymour, TN (US); Lance Tracy, Oak Ridge, TN (US); Greg Gillis, Escondido, CA (US); Brent A. Goetzl, Orinda, CA (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 12/353,687

(22) Filed: Jan. 14, 2009

(51) Int. Cl. G08B 23/00; A01K 15/02

(52) U.S. Cl. 340/573.3; 119/719; 119/720

(57) ABSTRACT

Described is a high-tech animal training system for delivering a stimulus to an animal and for providing a user with information relating to the ambient environment and to the operation of the animal training system, the information enabling the user to monitor and maintain the health and well-being of the animal. The animal training system delivers a stimulus to the animal such that the user is able to correct any undesired behavior exhibited by the animal and to reward any desired behavior exhibited by the animal. Additionally, the animal training system detects at least one an ambient condition and indicates the detected condition such that the user perceives the indication and is able to take action in protecting the animal from any detrimental conditions. The animal training system is also capable of storing data relating to the operation of the system and/or storing data input by the user.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention pertains to a system for training an animal. More particularly, this invention pertains to a system for delivering a stimulus to the animal and for providing an animal handler with information critical to maintaining the health and well-being of the animal.

2. Description of the Related Art

When training an animal, such as a dog, in the hunting field, an animal handler desires the ability to deliver a stimulus to the animal and desires access to critical information relating to the ambient environment. The handler desires the ability to deliver a stimulus to the animal such that the handler can correct the animal's undesired behavior and/or reward the animal's desired behavior. The handler desires access to the critical information, such as the ambient temperature or altitude, such that the handler can monitor the animal's health. When training in the field, the handler also desired access to information relating the operation of the system used to deliver a stimulus to the animal in the event the handler does not understand or fails to remember the operating instructions of the system.

Conventional animal training systems typically include a transmitter and a receiver, the receiver being carried by the animal. For example, the receiver is secured to an animal collar and the collar is secured to the animal. The transmitter is a handheld transmitter that is carried by the animal handler. The transmitter typically includes a limited plurality of pressable buttons. For example, most conventional transmitters include one (1) to four (4) buttons. Each button corresponds to a particular signal that is generated and wirelessly transmitted by the transmitter. For example, when a first pressable button is pressed, the transmitter generates and transmits a first signal, and when a second pressable button is pressed, the transmitter generates and transmits a second signal. The transmitter and the receiver are in wireless communication such that when the transmitter transmits a signal, the receiver receives the signal and performs a pre-set corresponding function. For example, when the receiver receives the first signal, it delivers an audible stimulus to the animal, and when the receiver receives the second signal, it delivers an electrical stimulus to the animal.

Conventional animal training systems are limited in that the transmitter does not provide the handler with access to critical information relating to the ambient environment or the system itself. More specifically, the conventional transmitter merely transmits signals to the receiver. Consequently, a system having a transmitter that provides an animal handler with access to the above-discussed critical information is desired.

### BRIEF SUMMARY OF THE INVENTION

In accordance with the various features of the present invention there is provided a high-tech animal training system for delivering a stimulus to an animal and for providing a user with information relating to the ambient environment and to the operation of the animal training system, the information enabling the user to monitor and maintain the health and well-being of the animal. The animal training system includes a transmitter module and a receiver module. The transmitter module includes a transmitter module processor, an ambient condition detector, a transmitter module display, a memory module, a stimulus activation switch, and a transmitter, whereby the transmitter module processor is in electrical communication with the ambient condition detector, the transmitter module display, the memory module, the stimulus activation switch, and the transmitter. The ambient condition detector detects an environmental condition, such as the ambient temperature, the polarity of the earth's magnetic field, or the altitude of the transmitter module. The transmitter module processor receives the detected condition and indicates the detected condition at the transmitter module display such that the indication is perceivable by the user of the animal training device. The memory module stores data relating to, among other things, the operation of the animal training system. For example, the memory module can store the user's manual for the animal training system. Data stored at the memory module is accessible by the transmitter module processor and is presented at the transmitter module display such that the data is perceivable by the user. The stimulus activation switch is operated by the user such that the transmitter module processor generates a stimulus activation signal in response to such operation and wirelessly transmits the stimulus activation signal by way of the transmitter.

The receiver module is carried by the animal and includes a receiver, a receiver module processor, and a stimulus delivery mechanism, whereby the receiver module processor is in electrical communication with the receiver and the stimulus delivery mechanism. The receiver receives the wirelessly transmitted stimulus activation signal and transfers the signal to the receiver module processor. When the receiver module processor receives the stimulus activation signal, it activates the stimulus delivery mechanism such that the stimulus delivery mechanism delivers a stimulus to the animal.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates one embodiment of the high-tech animal training system in accordance with the various features of the present invention;

FIG. 2 is a block diagram of one embodiment of the high-tech animal training system of FIG. 1;

FIG. 3 illustrates one embodiment of the transmitter module of the high-tech animal training system; and

FIG. 4 is a block diagram of an alternate embodiment of the high-tech animal training system of FIG. 1.

### DETAILED DESCRIPTION OF THE INVENTION

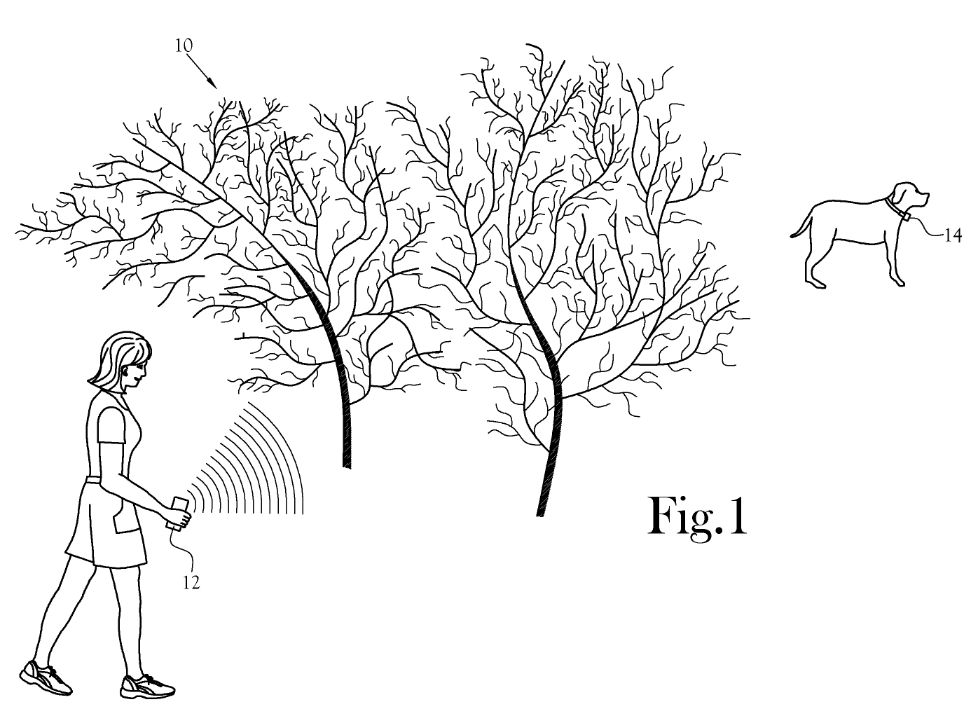

The present invention provides a high-tech animal training system for delivering a stimulus to an animal and for providing a user with information relating to the ambient environment and to the operation of the animal training system, the information enabling the user to monitor and maintain the health and well-being of the animal. The animal training system delivers a stimulus to the animal such that the user is able to correct any undesired behavior exhibited by the animal and to reward any desired behavior exhibited by the animal. Additionally, the animal training system detects at least one an ambient condition and indicates the detected condition such that the user perceives the indication and is able to take action in protecting the animal from any detrimental conditions. The animal training system is also capable of storing data relating to the operation of the system and/or storing data input by the user. One embodiment of the high-tech animal training system constructed in accordance with the various features of the present invention is illustrated generally at 10 in FIG. 1.

The high-tech animal training system 10 includes a transmitter module 12 and a receiver module 14. The receiver module 14 is carried by the animal. For example, in the illustrated embodiment, the receiver module 14 is secured to an animal collar, and the collar is secured to the animal. The transmitter module 12 is a device carried and operated by a user of the animal training system 10. For example, in the illustrated embodiment, the transmitter module 12 is a handheld device. The transmitter module 12 and the receiver module 14 are in wireless communication.

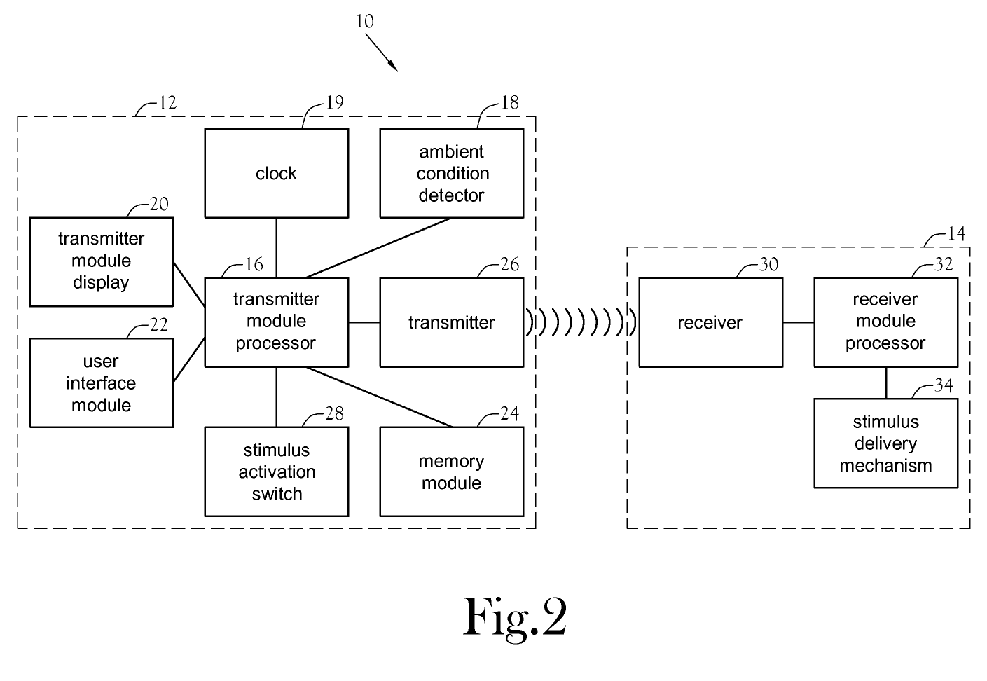

FIG. 2 is a block diagram of one embodiment of the animal training system 10. In the illustrated embodiment, the transmitter module 12 includes a transmitter module processor 16, at least one ambient condition detector 18, a clock 19, a transmitter module display 20, a user interface module 22, a stimulus activation switch 28, a memory module 24, and a transmitter 26, whereby the transmitter module processor 16 is in electrical communication with the ambient condition detector 18, the clock 19, the transmitter module display 20, the user interface module 22, the stimulus activation switch 28, the memory module 24, and the transmitter 26. The ambient condition detector 18 detects an ambient condition at the current location of the transmitter module 12 and generates a condition signal that is indicative of the detected condition. For example, the ambient condition detector 18 can be a thermistor for detecting the ambient temperature, a magnetometer for detecting the polarity of the earth's magnetic field, a pressure transducer for detecting the altitude of the transmitter module 12 with respect to sea level, a pressure transducer for detecting the ambient barometric pressure, or an inclinometer for detecting the angle of inclination of the transmitter module 12 with respect to the horizontal. It should be noted that the ambient condition detector 18 can be a detector other than the above-listed detectors without departing from the scope or spirit of the present invention. It should also be noted that the transmitter module 12 can include more than one ambient condition detector 18 without departing from the scope or spirit of the present invention.

The transmitter module processor 16 receives the condition signal generated by the ambient condition detector 18 and indicates the detected condition at the transmitter module display 20. The indication of the detected condition is displayed such that the indication is perceivable by the user to the extent that the user is made aware of the detected condition. The indication displayed at the transmitter module display 20 can be presented audibly and/or visually without departing from the scope or spirit of the present invention. The transmitter module processor 16 also receives a time signal from the clock 19. The time signal indicates the current time as kept by the clock 19. The transmitter module processor 16 presents the current time as kept by the clock 19 at the transmitter module display 20 such that the current time is perceivable by the user.

The user interface module 22 enables the user to communicate with the animal training system 10. In one embodiment, the user interface module 22 is integrated in the transmitter module display 20 as a touch-screen. In another embodiment, the user interface module 22 includes one or more buttons and/or switches operable by the user. For example, in one embodiment, the user interface module 22 enables the user to navigate menus displayed at the transmitter module display 20. In another embodiment, the user interface module 22 includes an alpha-numeric keypad that enables the user to enter data into the animal training system 10, the data being displayed at the transmitter module display 20. Additionally, in one embodiment, the user selects the mode of operation of the animal training device 10 using the user interface module 22. In one embodiment, the user selects the type of data displayed at the transmitter module display 20 using the user interface module 22. It should be noted that the user interface module 22 can include any type, number, or combination of controls operable by the user without departing from the scope or spirit of the present invention.

The memory module 24 stores data such that the stored data is accessible by the transmitter module processor 16. The data can be entered into memory module 24 by the user by way of the user interface module 22 or programmed into the memory module 24 at the time the animal training system 10 is manufactured. In one embodiment, the transmitter module 12 includes a computer interface in electrical communication with the transmitter module processor 16. The computer interface facilitates communication between the transmitter module 12 and a computer. In this embodiment, data can be transferred from the computer to the memory module 24 and from the memory module 24 to the computer. It should be noted that the computer interface can facilitate wired or wireless communication. The data stored at the memory module 24 can be, for example, the User's Manual for the animal training system 10 or a downloaded training video. Having resources such as these stored at the transmitter module 12 permits the user to reference the resources without having to prematurely terminate a training session in the field and to use the animal training system 10 more effectively. Data stored at the memory module 24 is accessed by the transmitter module processor 16 in response to the user interface module 22 and is displayed at the transmitter module display 20.

The stimulus activation switch 28 is a control operated by the user of the animal training system 10. The stimulus activation switch 28 can be any type of control, such as a pressable button, a biased toggle switch, or a touch-screen button of the transmitter module display 20. When the stimulus activation switch 28 is operated by the user, the transmitter module processor 16 generates a stimulus activation signal and wirelessly transmits the stimulus activation signal by way of the transmitter 26. The receiver module 14 is adapted to receive the wirelessly transmitted stimulus activation signal.

In the illustrated embodiment, the receiver module 14 includes a receiver 30, a receiver module processor 32, and a stimulus delivery mechanism 34, whereby the receiver module processor 32 is in electrical communication with the receiver 30 and the stimulus delivery mechanism 34. The receiver 30 receives the stimulus activation signal transmitted by the transmitter module 12. The receiver module processor 32 receives the stimulus activation signal from the receiver 30. When the receiver module processor 32 receives the stimulus activation signal, it activates the stimulus delivery mechanism 34 such that the stimulus delivery mechanism 34 delivers a stimulus to the animal. Stated differently, when the user operates the stimulus activation switch 28 of the transmitter module 12, the receiver module 14 delivers a stimulus to the animal. The stimulus can include any humane stimulus, such as an electric stimulus, an audible stimulus, or a vibration stimulus, without departing from the scope or spirit of the present invention. Additionally, it should be noted that the stimulus delivery mechanism 34 can be adapted to deliver more than one type of stimulus without departing from the scope or spirit of the present invention. For, example, the stimulus delivery mechanism 34 can be adapted to deliver both an electric stimulus and a vibration stimulus to the animal. In one embodiment, the transmitter module 12 includes a plurality of stimulus activation switches 28, each stimulus activation switch 28 corresponding to a different type of stimulus delivered by the stimulus delivery mechanism 34.

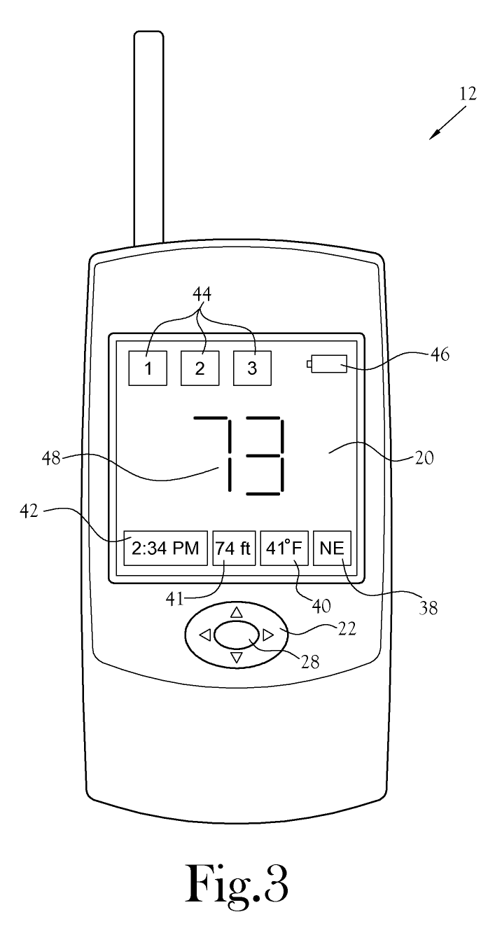

FIG. 3 illustrates one embodiment of the transmitter module 12 in accordance with the various features of the present invention. In the illustrated embodiment, the transmitter module 12 includes a magnetometer, a thermistor, and a pressure transducer. Additionally, the transmitter module 12 of the illustrated embodiment is adapted to operate with three independent receiver modules 14, namely a first receiver module, a second receiver module, and a third receiver module. The transmitter module display 20 of the illustrated embodiment is a visual display such as, for example, a dot matrix LCD display. In the illustrated embodiment, the transmitter module display 20 presents a compass direction, at 38, the ambient temperature, at 40, the altitude of the transmitter module 12, at 41, the current time, at 42, an indication of the particular receiver module 14 that the transmitter module 12 is currently in communication with, at 44, the current charge level of the power source of the transmitter module 12, at 46, and the current intensity level of the stimulus delivered to the animal, at 48. The intensity level of the stimulus ranges from 0 to 99 and is adjusted by the user by way of the user interface module 22. The user interface module 22 of the illustrated embodiment includes menu navigation buttons.

One application of the animal training system 10 is training a hunting dog in the field. In this application, the animal is the hunting dog and the user is a dog handler. Accordingly, the transmitter module 12 is carried by the handler and the receiver module 14 is carried by the dog. Considering the transmitter module 12 of FIG. 3, the handler corrects the dog's undesirable behavior by operating the stimulus activation switch 28, which, in the illustrated embodiment, is a pressable button, such that the receiver module 14 delivers a stimulus to the dog. As discussed above, the intensity level of the stimulus delivered to the dog is indicated at 48 of the transmitter module display 20. Additionally, the transmitter module 12 provides the handler with information that enables the handler to make informed decisions regarding the health and well-being of the dog. For example, the transmitter module 12 indicates the ambient temperature to the handler such that the handler is aware when the temperature reaches a level that is dangerous for the dog. Additionally, the transmitter module 12 indicates its altitude, and thus the altitude of the dog, such that the handler is aware when the oxygen level reaches a level that is dangerous for the dog. The transmitter module 12 also displays the current time and compass direction such that the handler and the dog do not become lost in the field or find themselves unintentionally in the field after nightfall.

As discussed above, the animal training system 10 of FIG. 3 is adapted to communicate with three independent receiver modules 14. This enables the handler to train three different dogs simultaneously, which enables the handler to train the dogs to work together. In the illustrated embodiment, the portions of the transmitter module display 20 at 44 are touch-screen buttons such that the handler uses the buttons to establish and reestablish communication between either the first receiver module, the second receiver module, or the third receiver module and the transmitter module 12. More specifically, the user presses the button 44 labeled “1” to establish communication with the first receiver module, the button 44 labeled “2” to establish communication with the second receiver module, and the button 44 labeled “3” to establish communication with the third receiver module. In one embodiment, each receiver module 14 is assigned a corresponding color. When the transmitter module 12 is in communication with a particular receiver module 14, the backlighting of the transmitter module display 20 has the hue of the corresponding color. For example, when the transmitter module 12 of FIG. 3 is in communication with the first receiver module, the backlighting is green. When the transmitter module 12 is in communication with the second receiver module, the backlighting is yellow. And when the transmitter module 12 is in communication with the third receiver module, the backlighting is blue. It should be noted that the touch-screen buttons used to establish and reestablish communication between the transmitter module 12 and various receiver modules 14 can be controls other than the touch-screen buttons without departing from the scope or spirit of the present invention.

In accordance with the above-discussion, the handler is able to keep a training log of each training exhibition using the transmitter module 12. More specifically, the handler enters data relating to a training session into the transmitter module 12 by way of the user interface module 22, the data being stored at the memory module 24. For example, the handler can note specific occurrences of a particular behavior of the dog to track the progress of the dog's training. Additionally, the handler can note particular game spotted, shot, and/or bagged during the session and the time and date of such occurrences. The handler can also note the particular hunters and dogs present for each session. Additionally, the handler can note the handler's traveled path such that the handler does not become lost in the field.

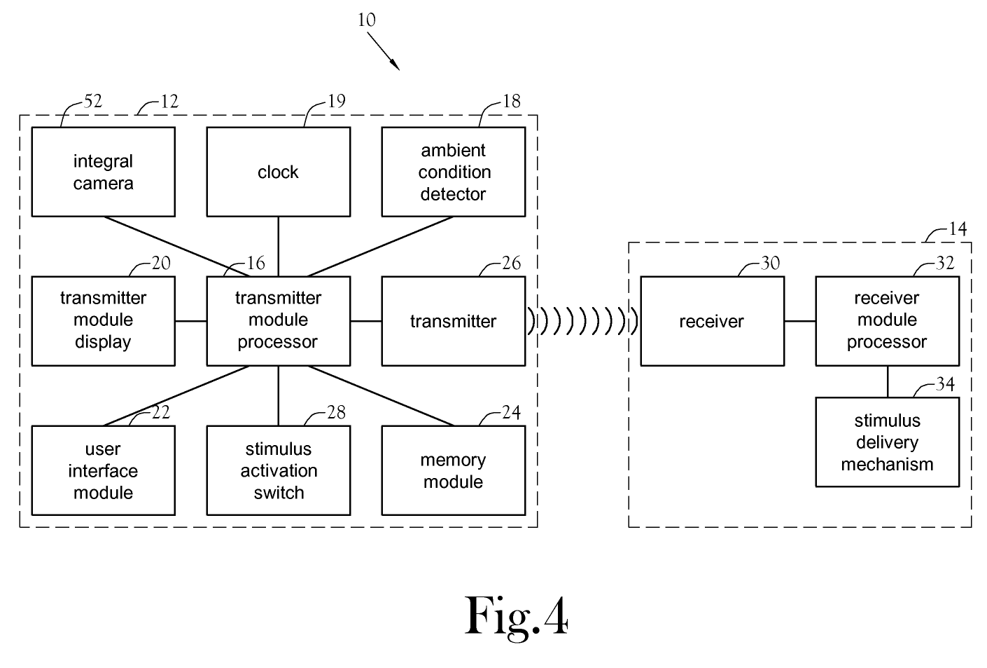

FIG. 4 illustrates an alternate embodiment of the animal training device 10 that includes an integral camera 52 in electrical communication with the transmitter module processor 16. In this embodiment, the handler operates the integral camera 52 using the user interface module 22 to capture images and/or video. The images and/or video captured by the integral camera 52 are stored at the memory module 24. This alternate embodiment of the animal training device 10 permits the user to, among other things, capture video of the animal for use in further training. In accordance with the above-discussion, in one embodiment, the user can transfer the captured images and/or video to a computer by way of the computer interface. Accordingly, the handler can maintain records regarding the training of a dog, various hunting trips, and notable locations in the field at the computer.

From the foregoing description, those skilled in the art will recognize that a high-tech animal training system for delivering a stimulus to an animal offering advantages over the prior art has been provided. The animal training system delivers a stimulus to the animal such that the user is able to correct any undesired behavior exhibited by the animal and to reward any desired behavior exhibited by the animal. Additionally, the animal training system detects at least one an ambient condition and indicates the detected condition such that the user perceives the indication and is able to take action in protecting the animal from any detrimental conditions. The animal training system is also capable of storing data relating to the operation of the system and/or storing data input by the user.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A high-tech animal training system for delivering a stimulus to an animal and for providing a user with information relating to the ambient environment, the information enabling the user to monitor and maintain the health and well-being of the animal, said high-tech animal training system comprising:
a transmitter module having a transmitter module processor, an ambient condition detector, a transmitter module display, a stimulus activation switch, and a transmitter, the transmitter module processor being in electrical communication with the ambient condition detector, the transmitter module display, the stimulus activation switch, and the transmitter, the ambient condition detector being adapted to detect an ambient condition and to generate a condition signal indicative of the detected ambient condition, the transmitter module processor receives the condition signal and activates the transmitter module display such that the transmitter module display indicates the detected ambient condition such that the indication is perceivable by the user, the transmitter module processor generates a stimulus activation signal when the stimulus activation switch is operated by the user, the transmitter module processor wirelessly transmits the stimulus activation signal by way of the transmitter; and
a receiver module adapted to be carried by the animal, said receiver module having a receiver module processor, a receiver, and a stimulus delivery mechanism, the receiver module processor being in electrical communication with the receiver and the stimulus delivery mechanism, the receiver being adapted to receive the wirelessly transmitted stimulus activation signal transmitted by way of the transmitter, the receiver module processor receives the stimulus activation signal from the receiver, the receiver module processor activates the stimulus delivery mechanism when the receiver module processor receives the stimulus activation signal such that the stimulus delivery mechanism delivers a stimulus to the animal.

2. The high-tech animal training system of claim 1 wherein said transmitter module includes a plurality of ambient condition detectors.

3. The high-tech animal training system of claim 1 wherein each of the plurality of ambient condition detectors is adapted to detect a different ambient condition.

4. The high-tech animal training system of claim 1 wherein the ambient condition detector is selected from the group consisting of a thermistor, a magnetometer, a pressure transducer, and an inclinometer.

5. The high-tech animal training system of claim 1 wherein the transmitter module display includes a visual display.

6. The high-tech animal training system of claim 5 wherein the transmitter module display includes a dot matrix LCD display.

7. The high-tech animal training system of claim 5 wherein the transmitter module display includes a segmented visual display.

8. The high-tech animal training system of claim 5 wherein the transmitter module display displays the compass direction of said transmitter module.

9. The high-tech animal training system of claim 1 wherein the transmitter module display includes an audible output.

10. The high-tech animal training system of claim 1 wherein said transmitter module includes a user interface module in electrical communication with the transmitter module processor, the user interface module enables the user to communicate with said high-tech animal training system.

11. The high-tech animal training system of claim 10 wherein the user interface module enables the user to navigate menus displayed at the transmitter module display.

12. The high-tech animal training system of claim 10 wherein the user interface module includes a touch-screen portion of the transmitter module display.

13. The high-tech animal training system of claim 10 wherein said transmitter module includes a memory module in electrical communication with the transmitter module processor, the memory module being adapted to store data.

14. The high-tech animal training system of claim 13 wherein the user interface module enables the user to enter data into the transmitter module processor, the data being stored at the memory module.

15. The high-tech animal training system of claim 14 wherein the transmitter module processor displays the data entered by the user at the transmitter module display.

16. The high-tech animal training system of claim 13 wherein the transmitter module processor displays data stored at the memory module at the transmitter module display.

17. The high-tech animal training system of claim 10 wherein the user interface module includes an alpha-numeric keypad.

18. The high-tech animal training system of claim 10 wherein the user interface module includes navigation buttons.

19. The high-tech animal training system of claim 10 wherein said transmitter module includes an integral camera in electrical communication with the transmitter module processor, the integral camera being operated by way of the user interface module.

20. The high-tech animal training system of claim 1 wherein said transmitter module includes a clock in electrical communication with the transmitter module processor, the clock providing the transmitter module processor with the current time, the transmitter module processor displaying the current time at the transmitter module display.

21. The high-tech animal training system of claim 1 wherein said receiver module includes a plurality of stimulus delivery mechanisms.

22. The high-tech animal training system of claim 21 wherein each of the plurality of stimulus delivery mechanisms is adapted to deliver a different stimulus.

23. The high-tech animal training system of claim 1 wherein the stimulus delivery mechanism is adapted to deliver a stimulus selected from the group consisting of an electric stimulus, an audible stimulus, and a vibration stimulus.

24. The high-tech animal training system of claim 1 wherein said transmitter module includes a computer interface in electrical communication with said transmitter module processor, said computer interface facilitates communication between the transmitter module processor and a computer.

25. The high-tech animal training system of claim 24 wherein said transmitter module receives data from the computer.

26. The high-tech animal training system of claim 24 wherein said transmitter module transfers data to the computer.

27. A high-tech animal training system for delivering a stimulus to an animal and for providing a user with information relating to the ambient environment, the information enabling the user to monitor and maintain the health and well-being of the animal, said high-tech animal training system comprising:
a transmitter module adapted to be carried by the user, said transmitter module being adapted to detect an ambient condition and indicate the detected ambient condition such that the indication is perceivable by the user, said transmitter module being adapted to wirelessly transmit a stimulus activation signal in response to the user; and
a receiver module adapted to be carried by an animal, said receiver module being adapted to receive the stimulus activation signal, said receiver module delivers a stimulus to the animal when said receiver module receives the stimulus activation signal.

28. The high-tech animal training system of claim 27 comprising a plurality of receiver modules, each of the plurality of receiver modules being adapted to be carried by an independent animal.

29. The high-tech animal training system of claim 28 wherein said transmitter module wirelessly transmits a plurality of stimulus activation signals, each of the plurality of stimulus activations signals corresponding to one of the plurality of receiver modules.

30. The high-tech animal training system of claim 27 wherein said transmitter module includes an ambient condition detection adapted to detect the ambient condition.

31. The high-tech animal training system of claim 27 wherein said transmitter module includes a transmitter module display adapted to indicate the detected ambient condition such that the indication is perceivable by the user.

32. The high-tech animal training system of claim 27 wherein said transmitter module includes an activation switch operable by the user, said transmitter module wirelessly transmits the stimulus activation signal when the activation switch is operated by the user.

33. The high-tech animal training system of claim 27 wherein said transmitter module includes a transmitter adapted to wirelessly transmit the stimulus activation signal.

34. The high-tech animal training system of claim 27 wherein said transmitter module indicates the current time such that the indication is perceivable by the user.

35. The high-tech animal training system of claim 27 wherein said transmitter module indicates the current date such that the indication is perceivable by the user.

36. The high-tech animal training system of claim 27 wherein said transmitter module includes a memory module adapted to store data, said transmitter module presenting the data such that the data is perceivable by the user.

37. The high-tech animal training system of claim 27 wherein said transmitter module includes an integral camera adapted to capture images.

38. The high-tech animal training system of claim 27 wherein said receiver module includes a receiver adapted to receive the stimulus activation signal.

39. The high-tech animal training system of claim 27 wherein said receiver module includes a stimulus delivery mechanism adapted to deliver a stimulus to the animal.

40. A high-tech animal training system for delivering a stimulus to an animal and for providing a user with information relating to the ambient environment, the information enabling the user to monitor and maintain the health and well-being of the animal, said high-tech animal training system comprising:
a transmitter module, said transmitter module comprising:
a transmitter module processor;
an ambient condition detector in electrical communication with said transmitter module processor, said ambient condition detector being adapted to detect an ambient condition and generate a condition signal indicative of the detected ambient condition, said transmitter module processor receives the condition signal;
a transmitter module display in electrical communication with said transmitter module processor, said transmitter module display indicates the ambient condition detected by said ambient condition detector, the indication being perceivable by the user;
a user interface module in electrical communication with said transmitter module processor, said user interface module enables the user to enter data into said transmitter module and otherwise communicate with said transmitter module, data entered by the user by way of said user interface module is displayed at said transmitter module display;
a memory module in electrical communication with said transmitter module processor, said memory module stores data entered by the user, said memory module stores data programmed into said transmitter module;
a stimulus activation switch in electrical communication with said transmitter module processor, said transmitter module processor generates a stimulus activation signal when the user operates said stimulus activation switch; and
a transmitter in electrical communication with said transmitter module processor, said transmitter wirelessly transmits the stimulus activation signal when said transmitter module processor generates the stimulus activation signal;
a receiver module adapted to be carried by the animal, said receiver module comprising:
a receiver module processor;
a receiver in electrical communication with said receiver module processor, said receiver adapted to receive the stimulus activation signal transmitted by said transmitter of said transmitter module; and
a stimulus delivery mechanism in electrical communication with said receiver module processor, said stimulus delivery mechanism delivers a stimulus to the animal when said receiver receives the wireless signal.

41. The high-tech animal training system of claim 40 wherein said transmitter module further comprises a computer interface in electrical communication with said transmitter module processor, said computer interface facilitates communication between said transmitter module and a computer.

42. The high-tech animal training system of claim 41 wherein said transmitter module processor receives data from the computer and stores the data at said memory module.

43. The high-tech animal training system of claim 41 wherein said transmitter module processor transfers data from said memory module to the computer.
